(19) United States
(12) Patent Application Publication
(10) Pub. No.: US 2011/0137771 A1
(43) Pub. Date: Jun. 9, 2011

(54) Method and Apparatus Pertaining to Provision and Use of a Unified Account Current and Statement Billing Workflow

(75) Inventor: Matthew Carl Hamilton, Pacifica, CA (US)

(73) Assignee: GUIDEWIRE SOFTWARE, INC., San Mateo, CA (US)

(21) Appl. No.: 12/631,386

(22) Filed: Dec. 4, 2009

(51) Int. Cl. G06Q 30/00; G06Q 20/00; G06Q 10/00

(52) U.S. Cl. 705/34

(57) ABSTRACT

A digital-computing platform provides a unified account current and statement billing workflow. This workflow comprises a plurality of event points including, for example, sending a statement, checking for receipt of a promise to pay, and checking for receipt of a payment. This platform uses an end-user interface to facilitate configuring a specific billing plan by use of this unified workflow. This can comprise configuring at least one action with respect to at least one of the aforementioned event points. By one approach, this can comprise providing an opportunity to select whether and when to send a statement, whether to receive a promise to pay, and/or a date by when to receive such a promise to pay. Configuring a specific billing plan can also comprise, if desired, providing an opportunity to identify an action to automatically take when an expected promise to pay is not received as expected.

### TECHNICAL FIELD

This invention relates generally to computer-based billing systems and more particularly to account-current billing and statement billing.

### BACKGROUND

Billing comprises a well-understood area of endeavor. Generally speaking, “billing” refers to activities to determine, and support the receipt of, amounts that are due in exchange for goods or services. This often comprises one or more acts to provide notice to a billed party regarding compensation that is presently due and payable. “Billing” can also include follow-up actions pertaining to the processing of received responses and/or late or incorrect responses. Digital computing platforms are often employed to facilitate billing activities for a given entity.

Insurance carriers often provide their products to end users via an intermediary agency. This agency may comprise essentially any legally-recognized entity ranging from a private individual to a partnership, corporation, or the like. Pursuant to such arrangements the agency typically receives payments from the end users and then provides some or all of these receipts to the carrier while either retaining a portion as their commission or receiving a return payment from the insurance carrier as a commission. (Brokers sometimes also have a similar relationship to insurance carriers. Although sometimes this description will use the more generic expression “producers” to refer to both agencies and brokers, it should be understood that for billing purposes “agencies” and “brokers” are sufficiently similar to one another that a specific reference to one in this description shall also comprise a reference to the other.)

There are two distinct approaches by which such an agency will make eventual payment on their agency bill policies to a carrier in the insurance industry. Pursuant to a first approach, often referred to as a statement-billing approach (and sometimes referred to as a company bill or a broker bill), the carrier calculates a bill and forwards the bill to the agency. The carrier then receives a corresponding payment from the agency. Frequently the received payment does not correspond exactly to the statement as a result of disagreements about commission amounts, terms of service, effective dates of the policy, claims made, and many other possible factors. In these cases an extensive negotiation and resolution process typically follows.

Pursuant to a second very-different approach, often referred to as an account-current approach, the agency calculates the payment and forwards to the carrier an expected promise to pay an identified amount. The carrier is responsible for examining the promise to pay, notifying the agency of any discrepancies between the promise and the carrier's expectation (discrepancies may arise for many of the same reasons as described in the case of statement-billing), and engaging with the agency to resolve the discrepancies. Later, the agency makes good on this promise (typically updated after resolving the discrepancies) and makes the corresponding payment to the carrier.

These two billing approaches are obviously quite different from one another and involve considerably different expectations and actions. In recognition of this, a typical computer-based billing platform will either support only one of these approaches or will provide logically separated and discrete support for both approaches. For example, when the carrier sets up a producer as an account-current producer, the billing platform provides a corresponding account-current-based end-user interface. The latter makes numerous presumptions regarding the billing process that are based upon the end-user's selection of the account-current approach. Similarly, when the carrier sets up a producer as a statement-billing producer, the billing platform provides a corresponding statement-billing end-user interface.

This bifurcated treatment, of course, well reflects historical billing practices and has always been presumed to best reflect the billing needs of carriers. The applicant, however, has determined that such is not necessarily always the case. In particular, there are many situations in which the applicant has determined that a combined approach would be of benefit, especially as an aid to reducing the chance and number of discrepancies to be resolved

### BRIEF DESCRIPTION OF THE DRAWINGS

The above needs are at least partially met through provision of the method and apparatus pertaining to provision and use of a unified account current and statement billing workflow described in the following detailed description, particularly when studied in conjunction with the drawings, wherein:

FIG. 1 comprises a block diagram as configured in accordance with various embodiments of the invention;

FIG. 2 comprises an illustrative screen shot as configured in accordance with various embodiments of the invention;

FIG. 3 comprises a flow diagram as configured in accordance with various embodiments of the invention; and

FIG. 4 comprises a work flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment may not be depicted in order to facilitate a less obstructed view of these various embodiments of the present invention. Certain actions and/or steps may be described or depicted in a particular order of occurrence while those skilled in the art will understand that such specificity with respect to sequence is neither required nor intended. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a digital-computing platform is configured to provide a unified account current and statement billing workflow. This workflow comprises a plurality of event points corresponding to both account-current and statement-billing events, including, for example, sending a statement, checking for receipt of a promise to pay, and checking for receipt of a payment. The unified workflow controls the overall process of billing the agency. This digital-computing platform uses an end-user interface to facilitate an end user configuring a specific billing plan to further control this unified workflow. This can comprise, for example, configuring at least one action with respect to at least one of the aforementioned event points.

The use of an agency billing plan, in combination with a unified workflow, provides many advantages. The unified workflow can be established once to guide the overall process for interacting with a number of agencies, but leaving for later the details regarding which actions to take or require, the time periods involved, and other details specific to a particular agency relationship to be defined in the billing plan. Many billing plans can thus be associated with a single workflow to allow different relationships to be established with different agencies. Furthermore, establishing a workflow is often a fairly complex activity that requires significant technical skill beyond the ken of the typical end user, as it may require an understanding of Boolean logic, control structures, loops, decision points, and so forth. By coupling it with a billing plan user interface that is simplified, and which allows a less-technical user to supply key parameters to the workflow to configure it for a specific agency relationship, a useful division of labor can be achieved.

It may be noted that, by one approach, such a workflow comprises a superset of all things possible as pertains to the billing business space. A user interface, however, permits the administrator or other end users to restrict what the workflow, in fact, makes available and hence possible. Those provides great flexibility to the implementing enterprise. For example, the enterprise can implement a phased roll-out of increased capabilities by managing plan attributes via the user interface without necessitating changes to the workflow itself. This might comprise, for example, using the user interface to expose (or hide, if desired) more parameters, control values, or the like that the workplan will accommodate. This, in turn, can help to avoid the time, expense, and other resource diversions necessary when undertaking the complex task of revising a workflow.

By one approach, so configuring a specific billing plan can comprise providing an opportunity to select whether to send a statement, when to send such a statement, whether to require a promise to pay, and a date by when to receive such a promise to pay. Configuring a specific billing plan can also comprise, if desired, providing an opportunity to identify an action to automatically take when an expected promise to pay is not received as expected.

Though providing a unified account-current and statement-billing workflow in combination with a corresponding end-user interface that provides such billing plan configuration opportunities is contrary to long-standing prior-art practice in these regards, the applicant has determined that such an approach need not confuse the end user and in fact can provide a degree of flexibility that better accords with the complications and deviations of modern billing experiences. These teachings are readily leveraged by digital-computing platforms and are easily scaled to accommodate both small and large billing requirements. These teachings also permit the strengths of one billing approach to be utilized and leveraged in favor of the other billing approach in a highly flexible and often intuitive manner. The disclosed practices can also be readily implemented without undue cost or complications.

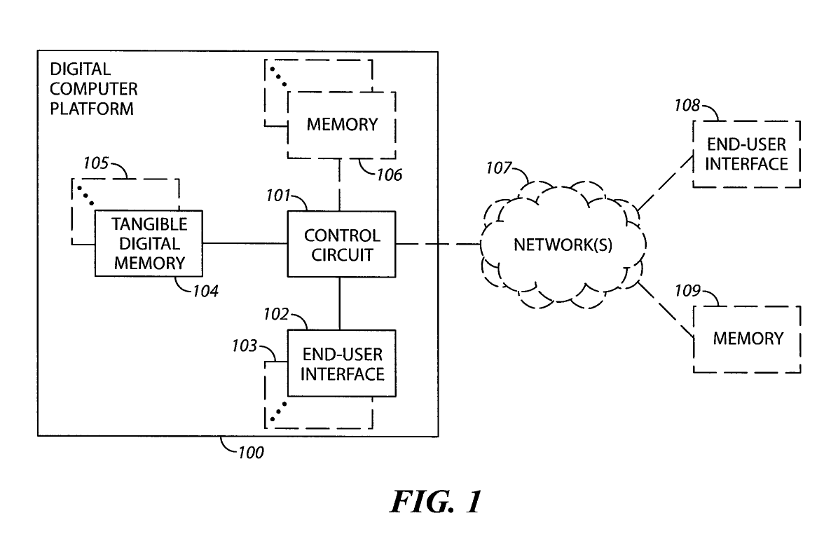

These and other benefits may become clearer upon making a thorough review and study of the following detailed description. Referring now to the drawings, and in particular to FIG. 1, an illustrative enabling platform that is compatible with many of these teachings will now be presented.

In this illustrative example the digital computer platform 100 comprises a control circuit 101 that operably couples to at least one end-user interface 102. This control circuit 101 can comprise a fixed-purpose hard-wired platform or can comprise a partially or wholly programmable platform. All of these architectural options are well known and understood in the art and require no further description here. The end-user interface 102 can comprise, by one approach, an end-user input mechanism such as, but not limited to, a keyboard, a keypad, a cursor-control device (such as a mouse, trackball, joystick, or the like), a touch-screen display, and so forth.

As denoted by reference numeral 103 there can be a plurality of end-user interfaces if desired. These can include additional end-user input mechanisms. These can also include output mechanisms such as, but not limited to active displays (such as liquid crystal displays, cathode ray tube displays, and so forth), one or more signal lights, audio transducers such as speakers and corresponding audio amplifiers, printers, and so forth. The particular mechanisms selected for use in a given application setting can of course vary with the needs and/or opportunities as tend to characterize each application setting.

In this illustrative example, the control circuit 101 will be presumed to comprise a programmable platform such as a digital computer of choice. In this case, the digital computer platform 100 also comprises a tangible digital memory 104. As denoted by reference numeral 105 there can be a plurality of such memories as desired. So configured, the tangible digital memory 104/105 can store a set of computer instructions. These computer instructions, when executed by a computer such as the control circuit 101, can cause the latter to act in accordance with the teachings set forth herein.

The control circuit 101 can also optionally couple to additional memory 106 if desired. This additional memory 106 can store data to be utilized by the control circuit 101 when executing the aforementioned computer instructions. This additional memory 106 can also serve to store the results of the control circuit's calculations if desired.

By one optional approach, the control circuit 101 can also operably couple to one or more networks 107. This can include a private local area network and/or public extranets such as the Internet. Such networks and the manner by which one compatibly interacts therewith are well known in the art and require no further description here. When communicatively coupled to such a network(s) 107, the control circuit 101 can further couple to such entities as one or more remotely-located end-user interfaces 108. So configured, the end-user activities described herein can themselves be carried out by remotely-located end users. (As used herein, the expression “remotely” will be understood to refer to either a significant physical separation (as when two objects are each physically located in discrete, physically-separated facilities such as two separate building) or a significant administrative separation (as when two entities are each administered and controlled by discrete, legally and operatively-separated entities).

Such a networked capability can also be used to operably couple the control circuit 101 to a remotely located memory 109 (or memories) such as a database, server, or the like. Such remotely-located memories can in turn provide the control circuit with data that is necessary or useful to its intended functionality.

Those skilled in the art will recognize and understand that such an apparatus may be comprised of a plurality of physically distinct elements as is suggested by the illustration shown in FIG. 1. It is also possible, however, to view this illustration as comprising a logical view, in which case one or more of these components can be enabled and realized via a shared platform. It will also be understood that such a shared platform may comprise a wholly or at least partially programmable platform as are known in the art.

So configured, the control circuit 101 can be programmed to provide a unified account-current and statement-billing workflow. As used herein the expression “workflow” will be understood to refer to a multi-step process to manage what typically amounts to a complex business practice. Workflows are particularly effective in settings where rules alone are insufficient to adequately ensure a desired result. Here, a workflow comprises, in part, a plurality of event points that, taken sequentially and in the aggregate, define the overall task (i.e., the events that take place during an agency billing cycle). These event points can include both machine-only event steps and human-input event steps. In the present example, these event points include, at least in part, sending a statement, checking for receipt of a promise to pay, and checking for receipt of a payment. (The word “statement” refers to a bill or invoice that informs the recipient of an amount that is owed for past or future benefits, services, or other consideration received.)

Generally speaking, workflow design and execution comprises a well-understood area of endeavor. Various approaches are known in the art in this regard. As these teachings are not overly sensitive to any particular selections in these regards, for the sake of brevity and the preservation of clarity, further elaboration in this regard will not be presented here except where pertinent to the description at hand.

Pursuant to these teachings this control circuit 101 is further programmed to interact with an end user (via, for example, the aforementioned end-user interface 102). This interaction facilitates the end user configuring a specific billing plan for a specific given first party such as an agency through which the insurance carrier provides products and services. These teachings can of course be applied with additional parties (such as a second party that is different from this party) to permit the configuration of uniquely specific billing plans for each of a plurality of parties.

This specific billing plan is configured to be used by the aforementioned unified account-current and statement-billing workflow. Accordingly, configuring the specific billing plan comprises, at least in part, configuring at least one action with respect to at least one of the aforementioned event points.

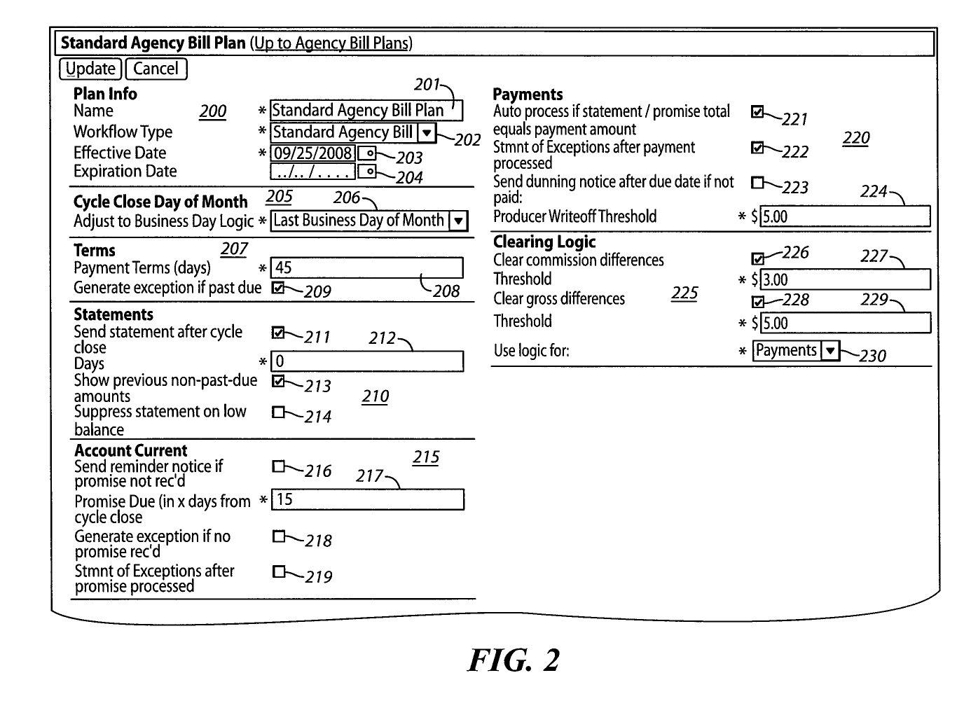

By one approach, this can comprise presenting a unified set of end-user-selectable event point opportunities (i.e., a set of opportunities that are unified in the sense that these opportunities include opportunities essentially unique in turn to both account-current billing and statement-based billing) via the end-user interface 102. Referring now to FIG. 2, such opportunities can be offered to the end user via a display 200 if desired. In such a case, these end-user-selectable opportunities can be provided with selection boxes and/or parameter-designation fields to permit the end user to make corresponding selections.

As illustrated, this display 200 can be laid out to essentially lead the end user through the opportunities in a relatively logical manner. By one approach, however, the end user can review and/or select any of the opportunities in any order of their choosing as the presentation of these opportunities does not impose a necessary order of review and selection.

A first portion 201 of the display 200 provides general information and fields pertaining to the specific billing plan being configured by the end user. Here, this includes a plan name 201, a workflow type identifier 202, an effective date 203 for when this billing plan becomes effective, and an expiration date 204 (if any). A next display portion 205 pertains to a cycle close day-of-month parameter 206. This opportunity permits the end user to select how the cycle close day of the month will be adjusted, if at all, to account for such things as non-business days. Options can include, for example, “exact day,” “first business day of month,” “last business day of month,” “next business day,” “previous day,” and “previous business day.”

The workflow type identifier 202 permits the user configuring the billing plan to choose a workflow to which the billing plan relates. In general, the workflow is designed to provide an overall structure for the billing process that can be further configured by a number of billing plans. An insurer may wish, however, to define more than one workflow. Such a need can arise, for example, when there are two or more different agency-billing processes. In this case, the user configuring the billing plan will select the workflow to use as part of configuring the billing plan. Note that the different workflows will still share common event points as can be configured by the billing plan, but the relationships between the event points, and the control structures around them, may be different in the different workflows.

The next display portion 207 pertains to terms. A corresponding field 208 specifies the number of days between the close date of the billing cycle and the due date for the statement associated with that cycle (in the example shown, forty-five days as the selected duration). A specific selection opportunity 209 permits the end user to have an exception generated when an issued statement remains unpaid beyond the selected duration. So configured, the end-user interface facilitates configuring a specific billing plan, in part, by providing an opportunity to the end user to select whether to receive payment by a particular date and further to automatically identify an action that must be taken when such a payment is not received as expected (for example, as an item to be automatically presented to a billing representative assigned to a particular producer when that representative logs in to the billing system).

A next display portion 210 pertains to statements and hence relates most specifically to traditional statement billing. A first selection opportunity 211 permits the end user to select whether to send a statement after the cycle closes. By declining to select this opportunity, no statement will be sent to the owing agency. A second selection opportunity 212 permits the end user to select when to send such a statement (in this illustrative example, the number of days after the close of a billing cycle for which the statement pertains). A next selection opportunity 213 permits the end user to select whether to show all previously unpaid invoice items (for example, from previous statements) regardless of whether such invoice items are past due or not. (By one approach, leaving this option unselected will result in a statement not showing unpaid invoice items that are past due (as of the cycle close date). By another approach, if desired, a separate selection opportunity can be provided to permit the end user to make a separate decision in these regards.) A final selection opportunity 214 in this illustrative example permits the end user to suppress the sending of a statement when the net invoiced amount is below a specified threshold (such as $5.00, $50.00, $100.00, or such other level as is appropriate to a given application setting).

Generally speaking, the length of a grace period on a statement is variable. Accordingly, when a next billing cycle comes around one may have previously-billed items that are either overdue (when the grace period is shorter than the billing cycle) or not yet due (when the grace period is longer than the billing cycle). The aforementioned approach is therefore seen to offer control over whether to present previously-billed items at all as well as offering finer control over whether to present only overdue items.

As these selection opportunities represent a unification of both account-current and statement-billing practices, and notwithstanding that many of the just-described opportunities pertain to statement-billing practices, the next display portion 215 presents selection opportunities that pertain in the first instance to account-current billing practices. In particular, these opportunities pertain to selecting whether to receive a promise to pay and the associated terms.

A first selection opportunity 216 permits the end user to select whether to automatically send a reminder notice to the agency if the agency has not sent in an account-current promise to pay. A next selection opportunity 217 permits the end user to specify the number of days by when the account-current promise to pay is to be received after the cycle close date. A third selection opportunity 218 in this illustrative example permits the end user to select whether to automatically generate an exception when the account-current promise to pay has not been timely received. And a fourth selection opportunity 219 permits the end user to select whether to automatically send a statement of exceptions (if any) to the promising party as pertains to their received promise to pay. Such a statement, for example, could identify when the promise to pay does not exactly match the statement for the cycle.

So configured, the end user has various opportunities to specify various account-current-like actions. These include but are not limited to opportunities regarding whether to receive a promise to pay, a date by when to receive such a promise, and to automatically identify one or more actions to take when the promise to pay is not received as expected.

A next display portion 220 pertains to payments. A first selection opportunity 221 permits the end user to select whether to automatically process a payment when the payment matches the corresponding statement or promise to pay. This opportunity, in turn, permits the end user to adopt a consistent approach regardless of whether employing an account-current approach, a statement-billing approach, or some new mixture of the two approaches.

A second selection opportunity 222 permits the end user to select whether to automatically send a statement of exceptions to the paying party after processing a received payment (to identify, for example, under or over-payments). A third selection opportunity 223 permits the end user to select to automatically send at least a first dunning notice when payment has not been received within some predetermined time (such as a given number of calendar days, or business days, following the payment due date). The fourth selection opportunity 224 permits the end user to specify a threshold amount, if any, for automatically writing off an inadequate proffered payment for a given overall total payment (such as, for example, $0.00, $0.01, $0.99, $5.00, or such other amount as may be preferred in a given application setting). Other possibilities in these regards are of course possible. For example, another selection opportunity could permit the end user to specify that the producer's policies be designated delinquent upon reaching a particular number of days of delinquency.

A last optional display portion 225 in this illustrative example pertains to clearing logic. A first selection opportunity 226 permits the end user to select whether to clear commission differences. Such a selection, for example, would permit the end user to select to automatically write off commission differences when the difference between a calculated commission and the agency's calculation is less than some predetermined threshold. By one approach, and as illustrated here, the end user can specify this predetermined threshold with respect to the corresponding individual statement line item at a second selection opportunity 227.

A third selection opportunity 228 permits the end user to select whether to clear gross differences. When selected, for example, the work flow could automatically write off gross differences when the amount is less than some threshold. By one approach, and again as illustrated here, the end user can specify this predetermined threshold at a fourth selection opportunity 229 as again applies with respect to a corresponding individual statement line item. A last selection opportunity 230 can permit the end user to select whether to use such clearance logic for payments, promises, or both. This clearing logic approach could also be applied when a payment comes with an electronic feed instructing how to distribute the payment. In particular, discrepancies as pertain to the distribution of such amounts could be handled in similar ways.

So configured, an end user can configure a given billing plan for a given corresponding party that is either account-current-centric or statement-billing-centric without being required to first identify a first category of billing practice. This unified approach also permits the end user to make use of actions that represent a mix of these two approaches. For example, it may be desirable with a given party to both send a statement and to hold this party to being responsible for producing a promise to pay a given identified amount by some date that either precedes, or follows, the statement date. Such capabilities yield a resultant flexibility that provides the billing party with considerably greater options to configure a billing plan that best accommodates the specific facts and concerns of a given situation.

Once configured, a billing plan (in combination with a unified workflow) can be associated with one or more agencies to control the billing activities with respect to the agency. At the end of each billing cycle for an agency, a workflow instance is created and executed by the billing system in combination with the billing plan associated with the agency. In general, executing a workflow is a well-understood technique, and is typically achieved by using a component that tracks the current step of the workflow and advances the workflow by executing any computer instructions associated with the step and then choosing, based on the result of those instructions and the definition of the workflow, a next step. Steps may include instructions to perform an action, to wait until an interval of time has passed, to wait until a condition has been met, or other instructions. The component executing the workflow is typically scheduled to run at regular intervals to advance any workflows that are ready to move to another step, for example if the current step is waiting for a time interval that has now expired. Many commercially available workflow engines exist for this purpose.

In the context of these teachings, execution of the workflow further comprises advancing through the steps defined by the workflow, and upon reaching the configurable event points, retrieving information from the billing plan to control the action taken by the billing system at that point. For example, when the billing system executes the event point in the workflow corresponding to the activity of sending a statement, the system retrieves the appropriate parameter from the billing plan to determine whether to send a statement. The billing system can further retrieve the information defining when the statement should be sent and use that information to schedule sending the statement. (As workflows that defer to an external source for parameters are well understood in the art, further elaboration in such regards need not be presented here.)

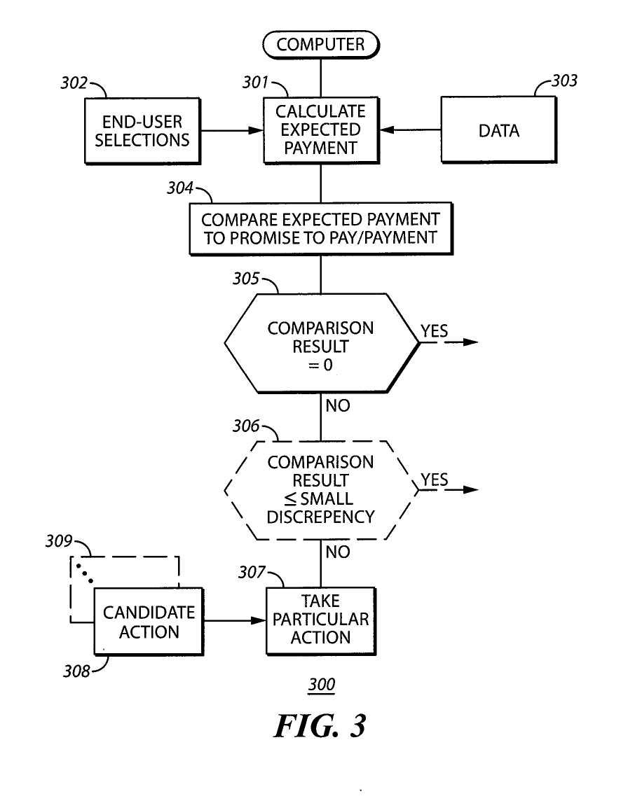

Selections entered by an end user in response to such selection opportunities serve to configure a particular billing plan for a particular corresponding party (or parties) to be billed. Certain illustrative examples in these regards will now be offered with respect to FIG. 3, where the steps of FIG. 3 represent further programming for the aforementioned control circuit 101.

In this illustrative process 300, at step 301 the enabling computer calculates an expected payment as corresponds to a given party for a given billing cycle (such as one month). This calculation can be informed as appropriate by end-user selections 302 and can of course take into account available data 303 regarding the terms and conditions to be applied, services and products provided, commissions to be paid, and so forth.

At step 304, this process 300 then provides for automatically comparing the calculated expected payment against a corresponding promise to pay and/or a payment as received from the given party. The comparison result will typically indicate whether the promised or paid amount matches the expected payment. The comparison result can also indicate, if desired, the amount by which the promised payment or the actual payment exceeds, or falls short of, the expected payment.

At step 305, when the comparison result is zero and hence reflects a perfect match between the expected payment and the received promise or received payment, this process 300 can carry on as desired. As these teachings will accommodate any number of possible actions in such an event, and as these alternatives are not necessarily pertinent to the immediate description, further details in such regards are not provided here.

When the comparison result is not zero, if desired, optional step 306 can determine whether the comparison result is no more than some predetermined small discrepancy. The value of what constitutes a small discrepancy can be adjusted and set as desired. By one approach this can comprise a global value established and maintained by a system administrator. By another approach, and as described above with respect to FIG. 2, an immediate end user can establish this value while configuring the corresponding billing plan.

When the comparison result does not exceed this small discrepancy threshold, the process 300 can carry on as desired. By one simple approach, for example, the discrepancy can simply be effectively ignored. By another simple approach, overpayments can be credited and underpayments can be debited to the given party's account and applied accordingly in the next billing cycle.

When the comparison result does exceed this small discrepancy threshold, or when otherwise not providing for this step 306, this process 300 provides for automatically taking some particular action via step 307. By one approach this can comprise selected from amongst a plurality of candidate actions (represented here by a first candidate action 308 through an Nth candidate action 309 (where “N” comprises an integer)).

By one simple approach, this particular action can comprise ignoring the discrepancy regardless of the size of the discrepancy. Other examples comprise, but are not limited to, sending a message to a promising party regarding the discrepancy, sending a message to a paying party regarding the discrepancy, sending a message to someone other than the promising/paying party (such as a person within the billing organization), and so forth.

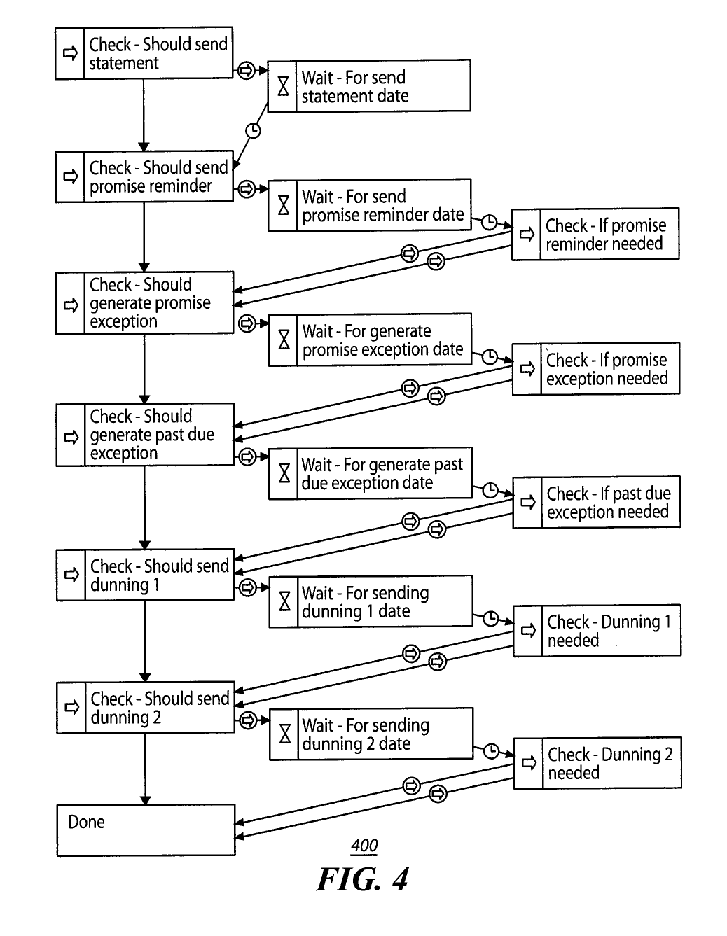

As noted above, these teachings will readily accommodate the close integration of such a unified billing process with a corresponding workflow. To further exemplify this point, a corresponding exemplary workflow diagram 400 is provided as FIG. 4. (In this illustrative example, some of the steps have two arrowed lines leading therefrom. These steps are of the form ChecklfXNeeded and the twin arrowed lines represent two possible actions where either then leads to the same next step. As one example in these regards, one such arrowed line for a given step might represent transferring control to the next step while the other arrowed line could represent both transferring control and executing a corresponding script.)

Read from the top, the workflow diagram 400 specifies a sequence of actions supporting both account current and statement billing. In the first step, for example, the workflow first determines if a statement should be sent. This decision is made by examining information about whether to send a statement as specified in the agency billing plan. If a statement should be sent, the workflow waits until the statement send date, also as specified in the agency billing plan, and then sends the statement. Similar operations are defined to check whether a promise reminder, promise exception, past due exception, and dunning letter(s) are required, and to send them as appropriate on the date as specified by the agency billing plan.

Other possibilities exist as well. Generally speaking, these teachings will accommodate supporting any automated or non-automated action for any previous account-current or any statement-billing process. These teachings will also accommodate, however, automated actions that were not previously considered or available that are based upon the described unified approach. As but one simple example in these regards, a significant discrepancy between a received promise to pay and the expected payment can result in an automated message to the promising party to alert them of the discrepancy, followed by an automated message to a responsible entity within the billing party if and when the payment as eventually received from the promising party remains largely divergent with respect to the expected payment.

Though unifying workflow event points as pertain to both account-current and statement-billing processes in a single workflow and user interface contravenes the logic and expectations of literally hundreds of years of practice, when undertaken with care and consideration as described herein the end result is a user-friendly, highly flexible, easily-learned (and even intuitive) mechanism for configuring a billing plan that is able to leverage the best of both approaches and yield a consolidated result that exceeds the sum of the individual institutional value of these individual approaches taken alone. As but one simple example in these regards, these teachings will readily permit an end user to accommodate and process receiving an (unexpected) promise to pay from a statement-billing agency; present billing processes are ill suited to deal with such an anomalous event.

These teachings also yield an approach to billing that is simpler and more streamlined than previous practices. Furthermore, the described unification ultimately eliminates a need for separate maintenance efforts for two discrete approaches thus saving corresponding expenses in these regards.

As another example of the benefits of these teachings, if an insurance carrier knows that there is a high chance of error in a particular billing period, they may choose to send a statement for advisory purposes to an agency that is normally operating in an account-current mode. This is usually impossible under current systems, since an account-current billing system typically has no means for generating and sending a statement. Similarly, an agency that normally operates in a statement-billing mode may choose, from time to time, to send a promise to pay when there is a significant chance of a dispute, allowing the insurer to examine the promise with respect to the statement and possibly modify the statement accordingly. This is not possible in a pure statement-billing system, which has no way of processing a promise to pay.

In yet another example of the benefits, an insurance carrier can easily switch an agency between statement billing and account current billing as needed or desired, simply by changing the billing plan for the agency. For example, an agency operating in account current mode that frequently provides inaccurate promises can be readily and easily switched over to statement billing for one or more billing cycles (or permanently as desired).

As competitive pressures have made the insurance market more complicated, and with more variation in products, pricing, sales strategies, commission rates, and other factors, the value of a more comprehensive and unified billing solution increases as well. In addition to supporting traditional billing approaches as described, these teachings will also readily support (and possibly even inspire) new approaches in these regards that will benefit both the billing and the billed parties.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A tangible digital memory having a set of computer instructions stored therein, which computer instructions when executed by a computer:
provide a unified account-current and statement-billing workflow, the workflow comprising a plurality of event points, wherein the plurality of event points comprise, at least in part:
sending a statement;
checking for receipt of a promise to pay; and
checking for receipt of a payment;
provide an end-user interface to facilitate an end user configuring a specific billing plan by use of the unified account-current and statement-billing workflow by, at least in part, configuring at least one action with respect to at least one of the event points.

2. The tangible digital memory of claim 1 wherein configuring a specific billing plan by configuring at least one action comprises providing an opportunity to select whether to send a statement.

3. The tangible digital memory of claim 2 wherein providing an opportunity to select whether to send a statement further comprises providing an opportunity to select when to send the statement.

4. The tangible digital memory of claim 1 wherein configuring a specific billing plan by configuring at least one action comprises providing an opportunity to select whether to receive a promise to pay.

5. The tangible digital memory of claim 4 wherein configuring a specific billing plan by configuring at least one action comprises providing an opportunity to select a date by when to receive the promise to pay.

6. The tangible digital memory of claim 4 wherein providing an opportunity to select whether to receive a promise to pay further comprises providing an opportunity to identify an action to automatically take when the promise to pay is not received as expected.

7. The tangible digital memory of claim 1 wherein configuring a specific billing plan by configuring at least one action comprises providing an opportunity to select whether to receive payment by a particular date.

8. The tangible digital memory of claim 7 wherein providing an opportunity to select whether to receive payment by a particular date further comprises providing an opportunity to identify an action to automatically take when the payment is not received as expected.

9. The tangible digital memory of claim 1 and further wherein the computer instructions, when executed by a computer:
calculate an expected payment.

10. The tangible digital memory of claim 9 and further wherein the computer instructions, when executed by a computer:
automatically compare the expected payment against either of:
the promise to pay; and
a payment;
when received to provide a comparison result.

11. The tangible digital memory of claim 10 and further wherein the computer instructions, when executed by a computer:
automatically take a particular action in response to the comparison result.

12. The tangible digital memory of claim 11 wherein the particular action comprises one of a plurality of candidate actions.

13. The tangible digital memory of claim 12 wherein the plurality of candidate actions further include:
ignoring the discrepancy regardless of a size of the discrepancy.

14. The tangible digital memory of claim 1 wherein configuring a specific billing plan comprises configuring a first specific billing plan for a first party and a second, different specific billing plan for a second party that is different from the first party.

15. An apparatus comprising:
an end-user interface;
a control circuit operably coupled to the end-user interface and configured to:
provide a unified account-current and statement-billing workflow, the workflow comprising a plurality of event points, wherein the plurality of event points comprise, at least in part:
sending a statement;
checking for receipt of a promise to pay; and
checking for receipt of a payment;
interact with an end user via the end-user interface to facilitate the end user configuring a specific billing plan by use of the unified account-current and statement-billing workflow by, at least in part, configuring at least one action with respect to at least one of the event points.

16. A method comprising:
via a digital computing platform:
providing a unified account-current and statement-billing workflow, the workflow comprising a plurality of event points, wherein the plurality of event points comprise, at least in part:
sending a statement;
checking for receipt of a promise to pay; and
checking for receipt of a payment;
using an end-user interface to facilitate an end user configuring a specific billing plan by use of the unified account-current and statement-billing workflow by, at least in part, configuring at least one action with respect to at least one of the event points.
